(19) United States
(12) Patent Application Publication
(10) Pub. No.: US 2015/0266533 A1
(43) Pub. Date: Sep. 24, 2015

(54) GUARD FOR THROTTLE CONTROL OF A MOTORIZED VEHICLE

(71) Applicant: MX Cross Designs Incorporated, Kingston (CA)

(72) Inventors: Thomas Patrick Schreider, Kingston (CA); James Kenneth Rogers, Athens (CA)

(21) Appl. No.: 14/667,217

(22) Filed: Mar. 24, 2015

Related U.S. Application Data
(60) Provisional application No. 61/969,507, filed on Mar. 24, 2014.

(51) Int. Cl. B62J 23/00; G05G 5/00

(52) U.S. Cl. CPC B62J 23/00; G05G 5/005

(57) ABSTRACT

A guard for a hand actuated throttle control of a motorized vehicle, wherein the guard comprises a guard member having a dimension defining an opening to receive the hand actuated throttle control, and an interior throttle space in communication with the opening for receiving the throttle control, the interior throttle space having a dimension greater than the throttle control to permit rotation of the guard relative to the throttle control, when in place.

This application claims priority based on U.S. Provisional Patent Application No. 61/969,507 entitled “GUARD FOR THROTTLE CONTROL OF A MOTORIZED VEHICLE” filed Mar. 24, 2014, which is herein incorporated by reference in its entirety.

### FIELD OF INVENTION

The invention relates to motorized vehicles having hand actuated throttle controls and in particular, the throttle controls for such vehicles.

### BACKGROUND

Numerous types of motorized vehicles utilize hand actuated controls for controlling the throttle, and thus the power output of the engine. Some examples include motorcycles, snowmobiles and all-terrain vehicles, which commonly use twistable controls mounted to the handlebar of the vehicle to control power output. Other examples include several types of light aircraft, which use hand actuated rods to control the power output of the aircraft's engine.

Vehicles such as those described above are often placed on display for the public, for example, at motorsport events or in the showrooms of retailers that sell the vehicles. Those viewing these vehicles are often tempted to sit in or on the vehicle, and to use its various controls, such as the throttle control. This is especially the case when the vehicle on display is unattended. While many of the controls are inactive when the vehicle is not running, the throttle control often is not. Rather, the throttle control often is physically connected to throttle mechanism of the engine; actuating the throttle when the engine is not running can therefore flood the engine with too much fuel. As well, actuation of the throttle control while the vehicle is not in use can lead to undue wear on, or damage to the springs and cables used in the linkage between the throttle control and the throttle mechanism, as well as the floats that maintain a suitable level of fuel in the vehicle's carburetor. As a result, it may be necessary to repair or replace these components before the vehicle is used.

In view of the foregoing, it would be desirable to prevent or impede the actuation of the throttle control of such vehicles when the engine is not running. It also would be desirable to have a device that can prevent or impede the actuation of the throttle control in situations where a vehicle is left on display unattended.

While there are several covers for throttle controls or switches that are known in the art, none is suitable for the purpose described above. The known throttle covers are intended to prevent only unintentional actuation of the throttle. They are designed specifically to allow the throttle to be actuated by a particular, deliberate movement of the user while the guard is mounted in place. None of the throttle covers known in the art is intended to or capable of preventing or impeding all actuation of the throttle control while the cover is in place.

### SUMMARY OF THE INVENTION

The invention provides a guard for a hand actuated throttle control of a motorized vehicle, wherein the guard comprises a guard member having a dimension defining an opening to receive the hand actuated throttle control, and an interior throttle space in communication with the opening for receiving the throttle control, the interior throttle space having a dimension greater than the throttle control to permit rotation of the guard relative to the throttle control, when in place.

### BRIEF DESCRIPTION OF THE DRAWINGS

FIG. 1 is a perspective view of an embodiment of the throttle control guard of the present invention.

FIG. 2 is an end view of the embodiment shown in FIG. 1, taken from a first end adjacent the opening 130.

FIG. 3 is an end view of the embodiment shown in FIG. 1, taken from a second end adjacent the cover 115, opposite the first end.

FIG. 4 is a perspective view of an alternative embodiment of the throttle control guard of the present invention.

FIG. 5 is an end view of the embodiment shown in FIG. 4, taken from a first end adjacent the opening 460.

FIG. 6 is an end view of the embodiment shown in FIG. 4, taken from a second end adjacent the cover 415, opposite the first end.

FIG. 7 is a cross-sectional view of the embodiment shown in FIG. 4, taken along the line 7-7 shown in FIG. 4.

### DETAILED DESCRIPTION OF EMBODIMENTS

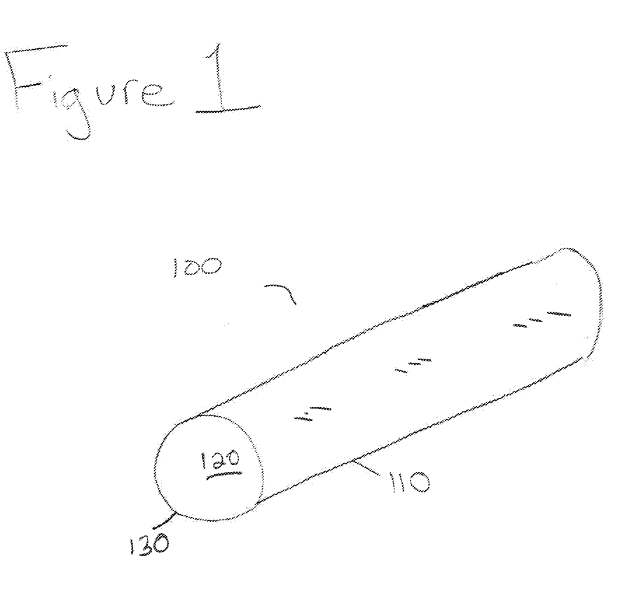

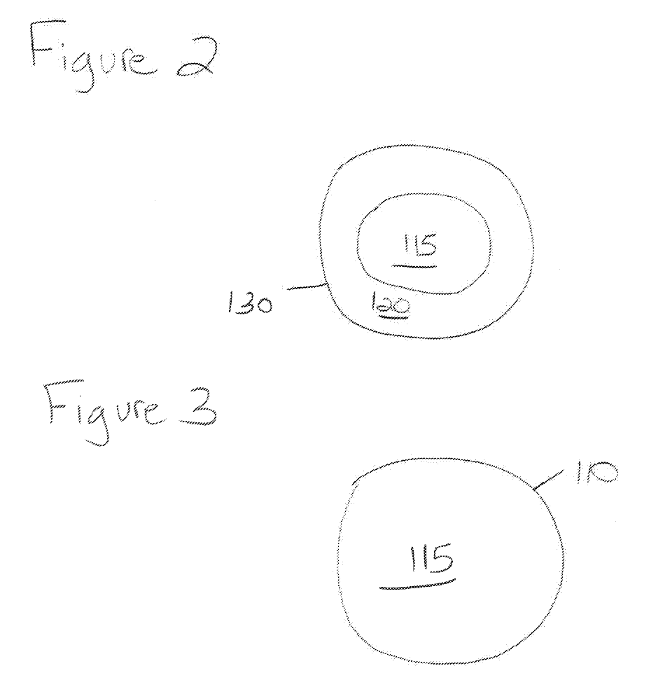

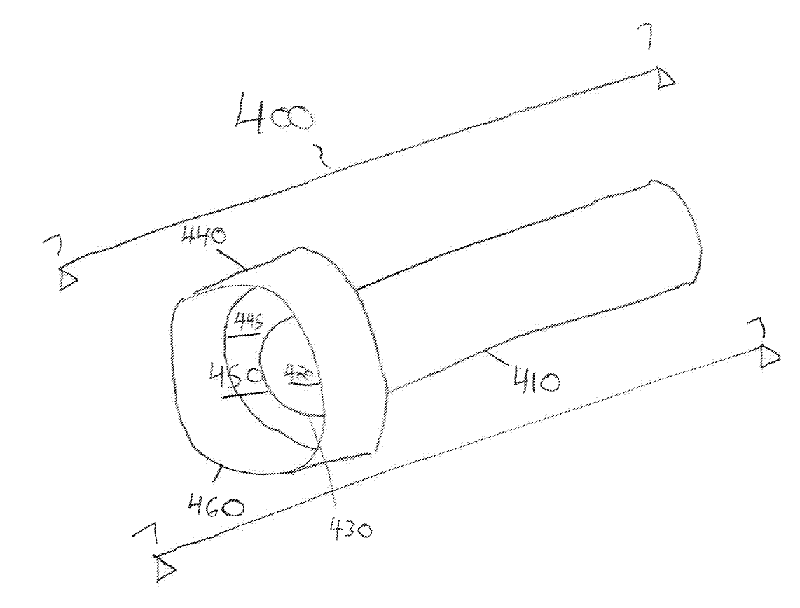

The invention will now be described with reference to the particular embodiments thereof depicted in the drawings. FIGS. 1, 2 and 3 depict one embodiment 100 of the throttle control guard of the present invention. The throttle control guard 100 comprises a guard member 110 that defines an interior throttle space 120 and an opening 130 thereto.

The guard member 110 is substantially cylindrical. A first end of the cylinder defines the opening 130 to the interior throttle space 120, while a second end of the cylinder, opposite the first end, comprises an end cover 115 that closes off the second end of the cylinder.

The guard member 110 and its end cover 115 can be made of any substantially rigid material that will not be substantially compressed by a force exerted by a person's hand. As will be described in greater detail below, the purpose of the guard member 110 is to prevent the actuation of a throttle control provided in the interior throttle space 120 by a person. Therefore, any substantially rigid material can be used to make the guard member 110 and end cover such that, when the guard member 110 is gripped by a person, the person cannot thereby engage and actuate the throttle control provided in the interior throttle space 120. One example of a suitable material for the guard member 110 and its end cover 115 is plastic, such as PVC. The guard member 110 also could be made of aluminum, steel or any other composite material.

The guard member 110, when made of PVC can be made using any known method for making components out of this material, such as injection molding. The end cover 115 is formed integrally with the guard member 110, although it will be appreciated that the end cover also could be a separate component that attaches to the guard member 110 by any suitable means.

The guard member 110 defines the interior throttle space 120 as a cylindrical space within the guard member 110. The interior throttle space 120 is in communication with the space outside the guard member by way of the opening 130.

The dimensions of the guard member 110 and end cover 115 are chosen to ensure that the interior throttle space 120 and opening 130 are properly sized to receive a hand actuated throttle control of a motor vehicle, such as a handlebar-mounted, twistable throttle control of a motorcycle, and to prevent actuation of the throttle control when the throttle guard 100 is in place. By way of example, the guard member 110 is substantially a cylinder having a length of 11 cm and a substantially circular cross section having a diameter of 3.5 cm. The end cover 115 is a substantially circular disc having a diameter matching that of the guard member 110.

With the above dimensions, it will be readily appreciated that the guard member 110 defines an opening 130 that is substantially circular and has a diameter of 3.5 cm. The guard member 110 also defines an interior throttle space 120 that is substantially cylindrical, has a length of 11 cm and a diameter of 3.5 cm. These dimensions are suitable to allow the handlebar-mounted twistable throttle control of some motorcycles to be inserted through the opening 130 into the interior throttle space 120. The dimensions also provide sufficient extra space in the interior throttle space 120 such that the guard member 110 does not fit snugly against the throttle control.

Those familiar with the field of motorcycles will know that the hand-actuated twist throttles used on these vehicles are not standardized, and come in many different varieties having different dimensions. As well, it is commonly known that other types of hand actuated throttle controls, other than a twist throttle control, are used on a variety of motor vehicles, and that the shapes and dimensions of such throttle controls also are not standardized. While the guard member 110 having the dimensions described above will fit suitably onto some throttle controls, it will not fit suitably onto many other types of throttle controls. Therefore, it will be apparent that the guard member 110 can be made in any shape, and having any dimensions, that are appropriate for a particular design of throttle control with which it is intended to be used. In particular, the guard member 110 can be of any shape or dimensions such that the interior throttle space 120 and opening 130 are appropriately sized to allow the throttle control to be provided therein, without the guard member 110 fitting snugly against the throttle control.

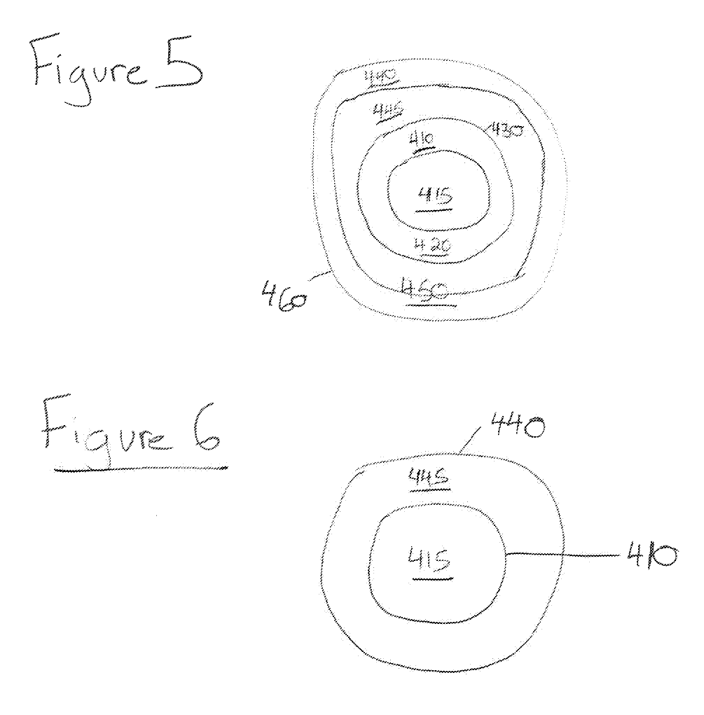

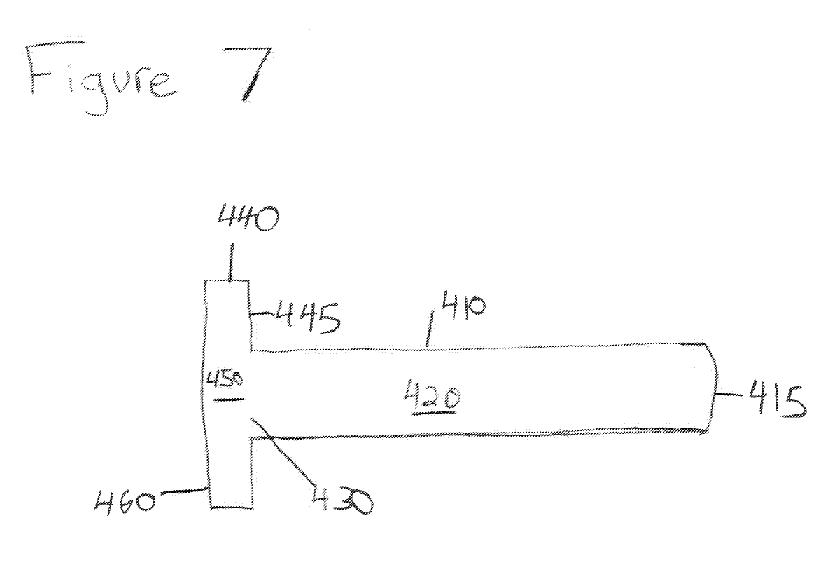

One example of a throttle guard having an alternative shape is shown in FIGS. 4-7. The embodiment 400 of the throttle control guard depicted in FIGS. 4-7 is intended for use on motorcycles having MX type handle grips installed on the throttle control. Such handle grips have a flared portion or flange at the inside edge of the handle grip and thus, the throttle control guard 400 is shaped to accommodate this flange.

Throttle control guard 400 comprises guard member 410 and end cover 415 that define an interior throttle space 420 and an opening 430 that are substantially similar to the guard member 100, end cover 115, interior throttle space 120 and opening 130 described above. Throttle control guard 400 also comprises a hand grip engaging member 440 that defines an interior hand grip space 450 and an opening 460 thereof.

The hand grip engaging member 440 is substantially cylindrical. It is formed integrally with the guard member 410 and is made of the same material as the guard member 410. It will be appreciated, however, that the hand grip engaging member 440 can be a separate component that is made of any material that would be suitable for the guard members 110, 410, and that attaches to the guard member 410 by any suitable means.

Although the hand grip engaging member 440 is substantially cylindrical like the guard member 410, it will be seen from the figures that the diameter of the hand grip engaging member 440 is larger than that of the guard member 410. The hand grip engaging member 440 extends out of the guard member 410 at the opening 430 via an annular end wall 445, which is integral with both the guard member 410 and the hand grip engaging member 440 and is made of the same material.

Hand grip engaging member 440 defines a substantially cylindrical interior hand grip space 450 therewithin. The hand grip engaging member 440 is in communication with the interior throttle space 420 defined by the guard member 410, via the opening 430 also defined by the guard member 410. The interior hand grip space 450 also is in communication with the area outside of the guard member 410 and hand grip engaging member 440 via the opening 460 defined at an end of the hand grip engaging member 440 opposite the annular end wall 445.

The dimensions of the hand grip engaging member 440 are selected such that the interior hand grip space 450 and opening 460 are dimensioned to receive a handlebar-mounted, twistable throttle control of a motorcycle and allow it to pass through the opening 430 into the interior throttle space 420. The dimensions of hand grip engaging member 440 also are selected such that the interior hand grip space 450 and opening 460 are dimensioned to receive the flared portion or flange at the inside end of an MX type handle grip, such that the hand grip engaging member 440 engages the outer edge of the flange on an interior surface of the member 440. Thus, if the throttle cover 400 is rotated while disposed on a throttle control, the throttle control will not be actuated. Rather, the throttle guard 400 will rotate harmlessly about the edge of the flange of the handle grip, and the throttle control within the interior throttle space 420 will not be actuated.

It will be appreciated that the hand grip engaging member 440 can have any suitable dimensions that will allow it to engage the outer edge of the flange of an MX type handle grip with which the throttle guard 400 is intended to be used. By way of example, guard member 440 is substantially cylindrical with a length of 1 cm and a circular cross section having a diameter of 7 cm.

Annular wall 445 is dimensioned essentially to connect guard member 410 to hand grip engaging member 440. By way of example, annular wall 445 is a substantially circular annulus having an outer diameter equal to the diameter of hand grip engaging member 440, and an inner diameter equal to the diameter of guard member 410.

To use either the throttle guard 100 or the throttle guard 400, one slides the throttle guard 100 or 400 over the throttle control to be covered by inserting the throttle control into the interior throttle space 120 or 420. This is done by inserting the throttle control through either the opening 130, or the opening 460, the interior hand grip space 450 and the opening 430. If the throttle guard 400 is being used and the motor vehicle in question has an MX type handle grip on the throttle control, the flared portion or flange of the MX type handle grip can be inserted into the interior hand grip space 450 via the opening 460, and the hand grip engaging member 440 can engage the outer edge of the flared portion or flange on the interior surface of the member 440.

Once the throttle guard 100 or 400 is in place, the throttle cannot be actuated without first removing the throttle cover 100 or 400. The interior throttle space 120 or 420 is dimensioned such that the guard member 110 or 410 does not snugly engage the throttle control. Thus, if the throttle guard 100 or 400 is rotated or otherwise moved, the movement does not actuate the throttle control. Furthermore, since the guard member 110 or 410 are made of substantially rigid material such as PVC, the throttle control cannot easily be actuated by squeezing the throttle guard 100 or 400 to engage the throttle control.

It will be appreciated by those of skill in the art that many variations of the particular embodiments described above are possible. The present invention is not intended to be limited to the embodiments described above, but rather is intended to include all such possible variations that will be apparent to those of skill in the art. Furthermore, the present invention is defined by the claims provided below, which are to be given the broadest possible interpretation that is consistent with this specification.

1. A guard for a hand actuated throttle control of a motorized vehicle, wherein said guard comprises a guard member having a dimension defining an opening to receive the hand actuated throttle control, and an interior throttle space in communication with the opening for receiving the throttle control, said interior throttle space having a dimension greater than the throttle control to permit rotation of the guard relative to the throttle control, when in place.

2. The guard of claim 1, wherein the guard member is substantially cylindrical, the opening is defined at a first end of the substantially cylindrical guard member and the interior throttle space is defined within the substantially cylindrical guard member.

3. The guard of claim 2, wherein the substantially cylindrical guard member is closed at a second end opposite the first end of the substantially cylindrical guard member.

4. The guard of claim 3, wherein the hand actuated throttle control comprises an elongate member rotatable about an elongate axis to provide throttle control, and the interior throttle space is dimensioned such that, when the throttle control is received within the interior throttle space, the guard member can be rotated about the elongate axis of the throttle control without actuating the throttle control.

5. The guard of claim 4, further comprising a substantially rigid hand grip engaging member extending from the guard member and defining:
an interior hand grip space in communication with the interior throttle space via the opening to the interior throttle space; and
an opening to the interior hand grip space for receiving the throttle control and a flared portion of a hand grip extending from the throttle control.

6. The guard of claim 5, wherein the hand grip engaging member is substantially cylindrical.

7. The guard of claim 6, wherein the hand grip engaging member comprises an annular wall extending from the guard member at a proximal end to a distal end spaced away from the proximal end, and a flange extending from the distal end of the annular wall to engage the flared portion of the hand grip.
